(19) United States
(12) Patent Application Publication
(10) Pub. No.: US 2025/0294546 A1
(43) Pub. Date: Sep. 18, 2025

(54) AVAILABILITY OF TRANSMISSION OCCASION BASED ON SUB-BAND FULL DUPLEX COLLISION

(71) Applicant: QUALCOMM Incorporated, San Diego, CA (US)

(72) Inventors: Diana MAAMARI, San Diego, CA (US); Abdelrahman Mohamed Ahmed Mohamed IBRAHIM, San Diego, CA (US); Muhammad Sayed Khairy ABDELGHAFFAR, San Jose, CA (US); Marwen ZORGUI, San Diego, CA (US); Ahmed Attia ABOTABL, San Diego, CA (US); Huilin XU, Temecula, CA (US)

(21) Appl. No.: 18/603,399

(22) Filed: Mar. 13, 2024

(51) Int. Cl. H04W 72/1268; H04W 56/00; H04W 72/0446; H04W 72/1273

(52) U.S. Cl. CPC H04W 72/1268; H04W 56/0015; H04W 72/0446; H04W 72/1273

(57) ABSTRACT

Various aspects of the present disclosure generally relate to wireless communication. In some aspects, a user equipment (UE) may receive a semi-static physical uplink shared channel (PUSCH) or physical uplink control channel (PUCCH) configuration. The UE may selectively transmit, in accordance with the semi-static PUSCH or PUCCH configuration, a PUSCH communication or a PUCCH communication in a PUSCH transmission occasion or a PUCCH transmission occasion of a sub-band full duplex (SBFD) slot based at least in part on an availability of the PUSCH transmission occasion or the PUCCH transmission occasion. The PUSCH transmission occasion or the PUCCH transmission occasion may be unavailable when the PUSCH transmission occasion or the PUCCH transmission occasion at least partially collides with a tracking reference signal (TRS), a physical downlink control channel (PDCCH) monitoring occasion (MO) or search space (SS), or a synchronization signal block (SSB). Numerous other aspects are described.

### FIELD OF THE DISCLOSURE

Aspects of the present disclosure generally relate to wireless communication and specifically relate to techniques, apparatuses, and methods for availability of transmission occasions based at least in part on sub-band full duplex (SBFD) collisions.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a user equipment (UE). The apparatus may include one or more memories and one or more processors coupled to the one or more memories. The one or more processors may be configured to cause the UE to receive a semi-static physical uplink shared channel (PUSCH) or physical uplink control channel (PUCCH) configuration. The one or more processors may be configured to cause the UE to selectively transmit, in accordance with the semi-static PUSCH or PUCCH configuration, a PUSCH communication or a PUCCH communication in a PUSCH transmission occasion or a PUCCH transmission occasion of a sub-band full duplex (SBFD) slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a tracking reference signal (TRS), a physical downlink control channel (PDCCH) monitoring occasion (MO) or search space (SS), or a synchronization signal block (SSB).

Some aspects described herein relate to an apparatus for wireless communication at a network node. The apparatus may include one or more memories and one or more processors coupled to the one or more memories. The one or more processors may be configured to cause the network node to transmit a semi-static PUSCH or PUCCH configuration. The one or more processors may be configured to cause the network node to selectively receive, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Some aspects described herein relate to a method of wireless communication performed by a UE. The method may include receiving a semi-static PUSCH or PUCCH configuration. The method may include selectively transmitting, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Some aspects described herein relate to a method of wireless communication performed by a network node. The method may include transmitting a semi-static PUSCH or PUCCH configuration. The method may include selectively receiving, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Some aspects described herein relate to a non-transitory computer-readable medium that stores a set of instructions for wireless communication by a UE. The set of instructions, when executed by one or more processors of the UE, may cause the UE to receive a semi-static PUSCH or PUCCH configuration. The set of instructions, when executed by one or more processors of the UE, may cause the UE to selectively transmit, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Some aspects described herein relate to a non-transitory computer-readable medium that stores a set of instructions for wireless communication by a network node. The set of instructions, when executed by one or more processors of the network node, may cause the network node to transmit a semi-static PUSCH or PUCCH configuration. The set of instructions, when executed by one or more processors of the network node, may cause the network node to selectively receive, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Some aspects described herein relate to an apparatus for wireless communication. The apparatus may include means for receiving a semi-static PUSCH or PUCCH configuration. The apparatus may include means for selectively transmitting, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Some aspects described herein relate to an apparatus for wireless communication. The apparatus may include means for transmitting a semi-static PUSCH or PUCCH configuration. The apparatus may include means for selectively receiving, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex communication in a wireless network, in accordance with the present disclosure.

FIG. 5 is a diagram illustrating examples of non-transparent sub-band full duplex (SBFD) operation for transmission and reception in SBFD symbols, in accordance with the present disclosure.

FIG. 6 is a diagram illustrating tables summarizing collision handling rules for non-transparent SBFD operation, in accordance with the present disclosure.

FIG. 7 is a diagram illustrating an example of SBFD coverage gain in an urban microcellular (UMa) environment with UE clustering, in accordance with the present disclosure.

FIG. 8 is a diagram illustrating an example of a two-step procedure for counting repetitions, in accordance with the present disclosure.

FIG. 9 is a diagram illustrating an example associated with transmission occasion availability based at least in part on SBFD collisions, in accordance with the present disclosure.

FIG. 10 is a diagram illustrating an example associated with available slot determinations for physical uplink control channel (PUCCH) repetitions, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Uplink/downlink collision handling rules may be defined to determine whether a half-duplex user equipment (UE) is to perform transmission or reception in sub-band full duplex (SBFD) scenarios. For example, in some SBFD collision handling cases, physical uplink shared channel (PUSCH) occasions that collide with semi-static downlink tracking reference signals (TRSs) or physical downlink control channel (PDCCH) monitoring occasions (MOs) may be dropped. Such semi-static collisions are a relatively recent development because SBFD is an emerging technology. In some examples, SBFD collision rules (e.g., a rule requiring that PUSCH occasions that collide with semi-static downlink TRS or PDCCH MOs are to be dropped) may be applied in scenarios where downlink and uplink transmissions can coincide at certain times.

Although some coverage enhancements, such as available slot counting, have been introduced, PUSCH occasions that are dropped due to SBFD collision rules have not been accounted for with respect to available slot counting. For example, whether to count PUSCH occasions that are dropped due to collisions with TRSs or PDCCH MOs toward repetitions is unresolved. Counting these semi-static dropped PUSCH or PUCCH communications toward repetitions may use excessive UE resources (e.g., processing or computing resources).

Various aspects relate generally to transmission occasion availability based at least in part on SBFD collisions. Some aspects more specifically relate to a PUSCH communication or a PUCCH communication that is selectively transmitted or received in accordance with a semi-static PUSCH or PUCCH configuration. For example, the PUSCH communication or the PUCCH communication may be configured by the semi-static PUSCH or PUCCH configuration. A UE may selectively transmit, and a network node may selectively receive, the PUSCH communication or the PUCCH communication in a PUSCH transmission occasion or a PUCCH transmission occasion of an SBFD slot based at least in part on an availability of the PUSCH transmission occasion or the PUCCH transmission occasion.

Whether the PUSCH or PUCCH transmission occasion is unavailable may depend on whether the PUSCH or PUCCH transmission occasion at least partially collides with a TRS, a PDCCH MO or search space (SS), or a synchronization signal block (SSB). For example, the PUSCH or PUCCH transmission occasion may be unavailable (e.g., considered invalid) if the PUSCH or PUCCH transmission occasion at least partially collides with one or more symbols of the TRS, the PDCCH MO or SS, or the SSB. The PUSCH or PUCCH transmission occasion may be available if the PUSCH or PUCCH transmission occasion does not at least partially collide with the TRS, the PDCCH MO or SS, or the SSB. In some examples, the PUSCH or PUCCH transmission occasion may at least partially collide with the TRS, the PDCCH MO or SS, or the SSB if at least one symbol of the PUSCH or PUCCH transmission occasion overlaps with at least one symbol of the TRS, the PDCCH MO or SS, or the SSB.

In some aspects, the PUSCH transmission occasion or the PUCCH transmission occasion at least partially collides with the TRS, the PDCCH MO or SS, or the SSB when at least one symbol of a time domain resource allocation (TDRA) associated with the PUSCH or PUCCH transmission occasion collides with the TRS, the PDCCH MO or SS, or the SSB. For example, the UE may determine K available slots for K repetitions. A slot may be considered to be available (e.g., valid) if all of the symbols contained in the TDRA for the slot are uplink or flexible symbols (e.g., as indicated by a tdd-UL-DL-ConfigurationCommon parameter and/or a tdd-UL-DL-ConfigurationDedicated parameter), are not used for SSB transmission (e.g., as per an SSBPositionsInBurst parameter), and do not collide with the TRS, the PDCCH MO or SS, or the SSB.

Particular aspects of the subject matter described in the present disclosure can be implemented to realize one or more of the following potential advantages. In some examples, the PUSCH transmission occasion or the PUCCH transmission occasion being unavailable when the PUSCH transmission occasion or the PUCCH transmission occasion at least partially collides with the TRS, the PDCCH MO or SS, or the SSB, may enable the described techniques to account for SBFD collision rules for purposes of available slot counting (e.g., counting PUSCH or PUCCH transmission occasions for repetition, transport block (TB) processing over multiple slots (TBoMS), or the like). For example, the UE may avoid counting semi-static dropped PUSCH or PUCCH communications, thereby reducing UE resources (e.g., processing or computing resources) occupied by available slot counting and/or further increasing coverage under SBFD.

The PUSCH transmission occasion or the PUCCH transmission occasion at least partially colliding with the TRS, the PDCCH MO or SS, or the SSB when at least one symbol of the TDRA collides with the TRS, the PDCCH MO or SS, or the SSB, may enable the UE to avoid counting a slot that the UE will later drop, thereby further conserving UE resources.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

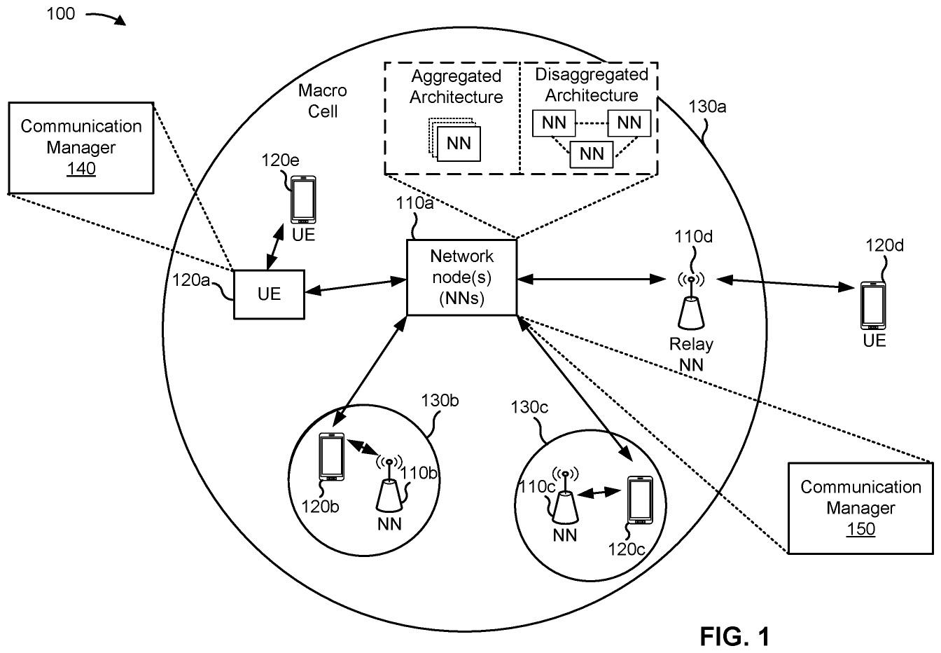

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHZ through 24.25 GHZ), FR4a or FR4-1 (52.6 GHz through 71 GHz), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long-Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility clement, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a semi-static PUSCH or PUCCH configuration; and selectively transmit, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB. Additionally, or alternatively, the communication manager 140 may perform one or more other operations described herein.

In some aspects, the network node 110 may include a communication manager 150. As described in more detail elsewhere herein, the communication manager 150 may transmit a semi-static PUSCH or PUCCH configuration; and selectively receive, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB. Additionally, or alternatively, the communication manager 150 may perform one or more other operations described herein.

As indicated above, FIG. 1 is provided as an example. Other examples may differ from what is described with regard to FIG. 1.

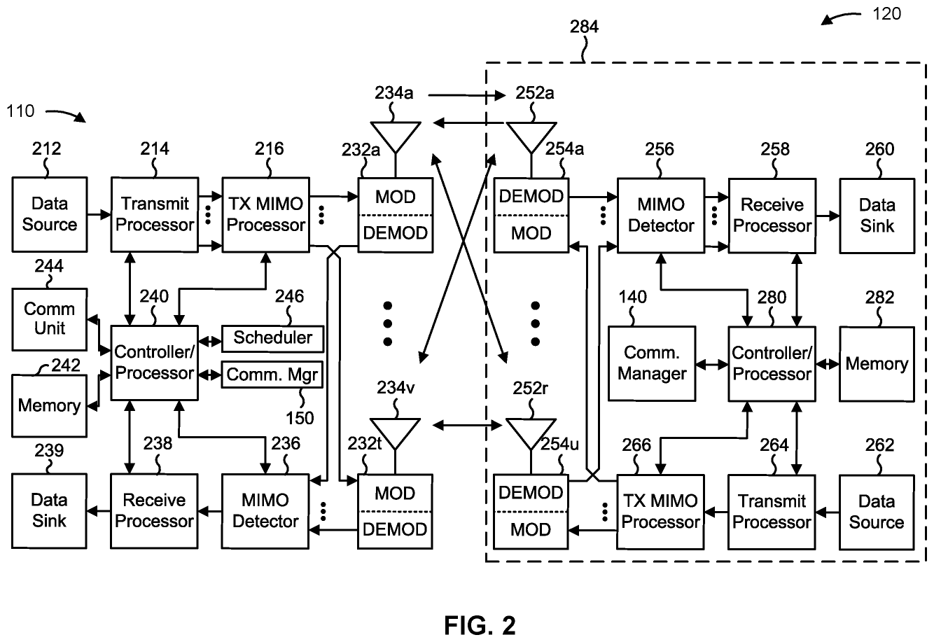

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more TBs of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-clement cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

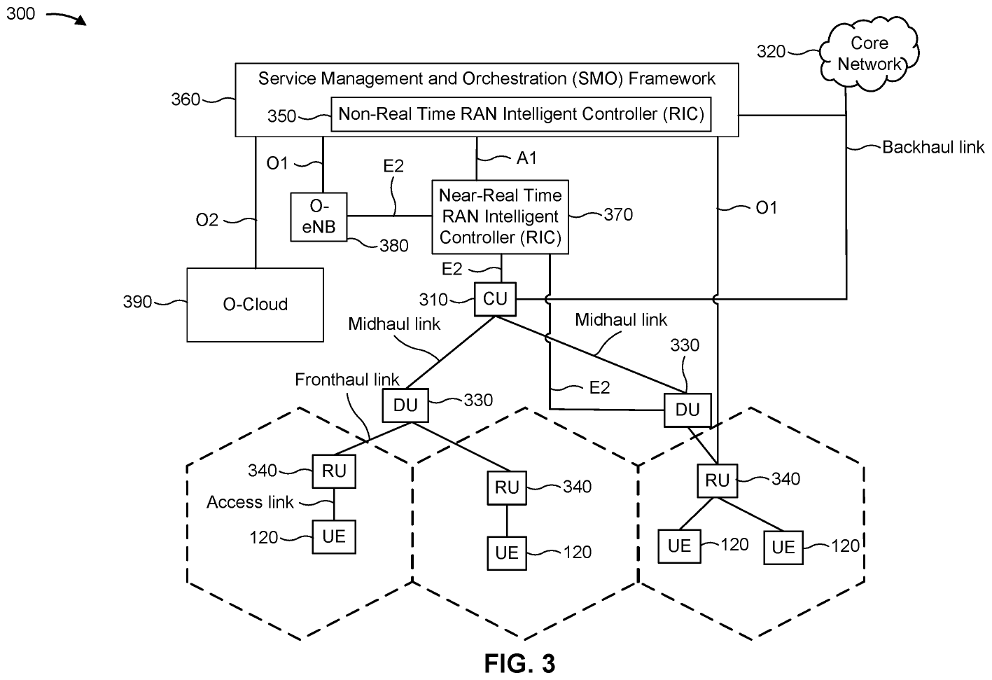

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

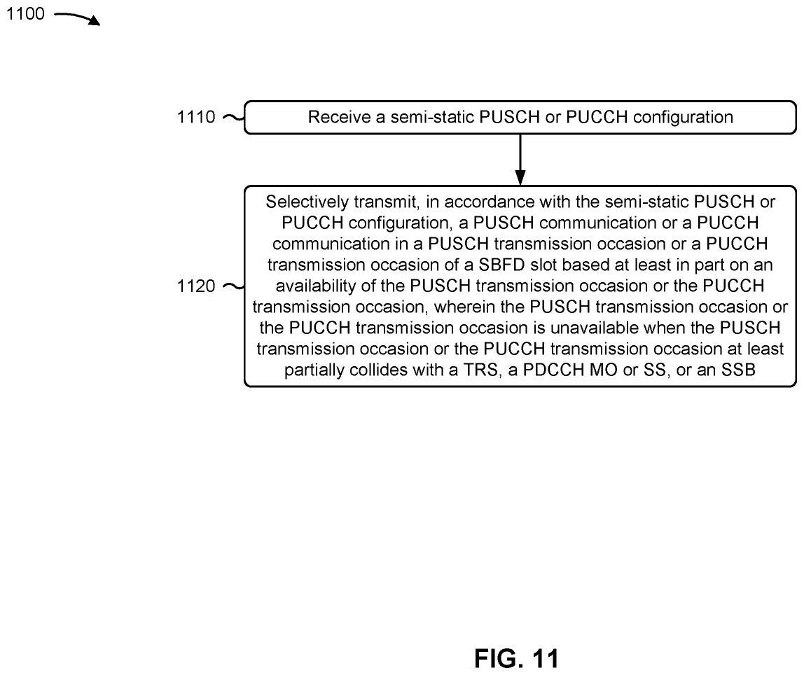

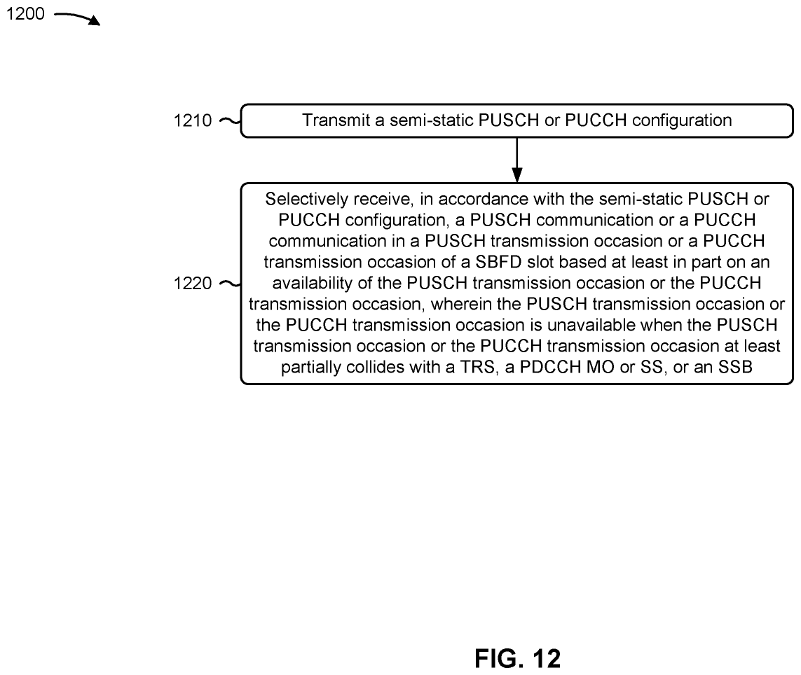

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with availability of transmission occasions based at least in part on SBFD collisions, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, the UE 120 includes means for receiving a PUSCH or PUCCH configuration; and/or means for selectively transmitting, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a semi-static PUSCH or PUCCH configuration; and/or means for selectively receiving, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

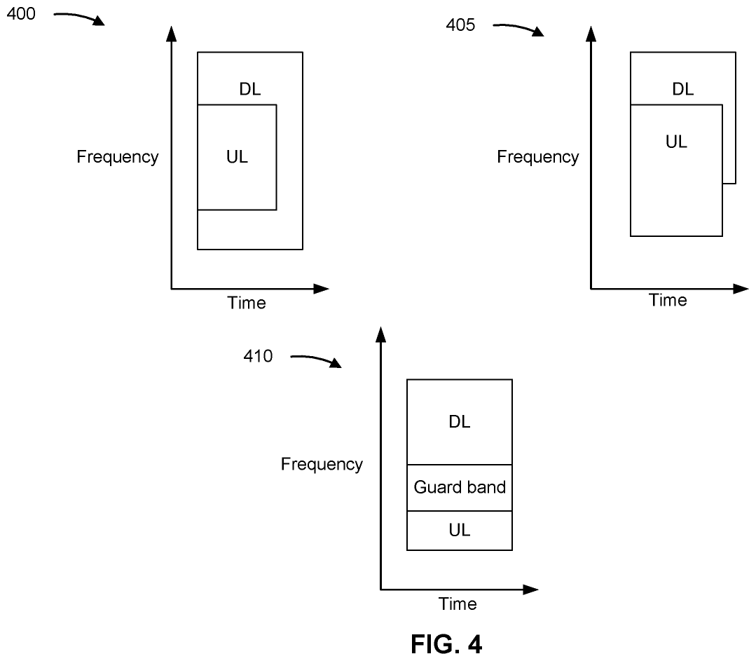

FIG. 4 is a diagram illustrating examples 400, 405, and 410 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). For example, a downlink BWP and an uplink BWP may be active at the same time. “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of SBFD communication, which may also be referred to as “sub-band frequency division duplex” (abbreviated as SBFDD) or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 4 is provided as an example. Other examples may differ from what is described with respect to FIG. 4.

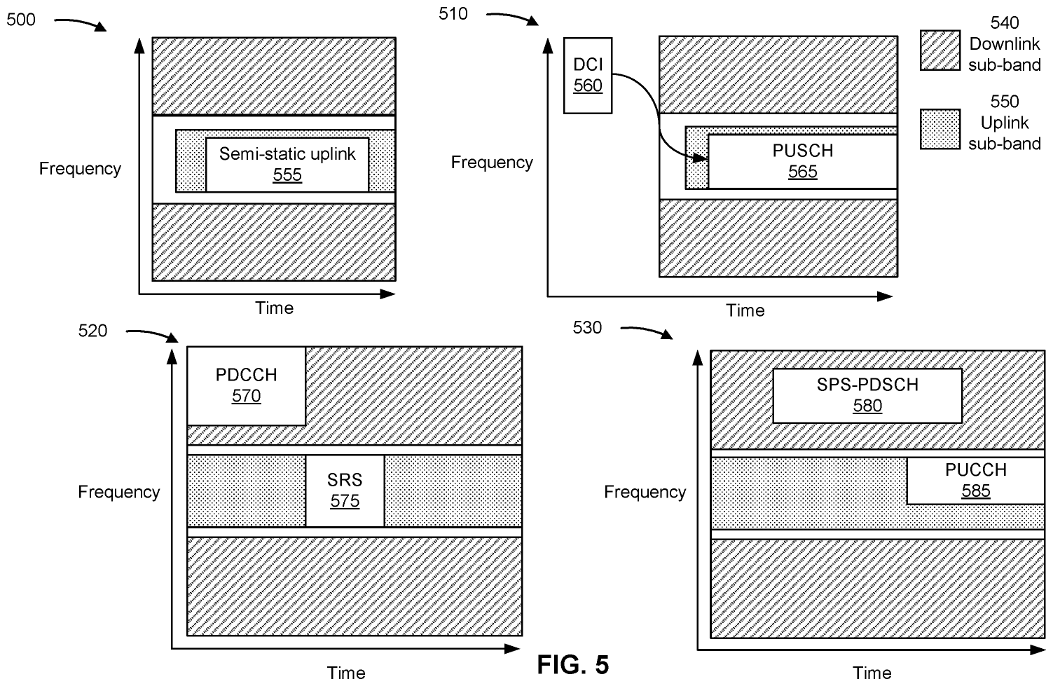

FIG. 5 is a diagram illustrating examples 500, 510, 520, and 530 of non-transparent SBFD operation for transmission and reception in SBFD symbols, in accordance with aspects of the present disclosure. Each of the examples 500, 510, 520, and 530 in FIG. 5 shows an SBFD symbol configured with downlink sub-bands 540 and an uplink sub-band 550.

Examples 500 and 510 relate to how a UE 120 may determine whether to transmit or receive in an SBFD symbol by treating the SBFD symbol as a flexible symbol. As shown in example 500, the UE 120 may determine traffic direction based at least in part on semi-static signaling (e.g., semi-static uplink communication 555). As shown in example 510, the UE 120 may determine traffic direction based at least in part on dynamic scheduling (e.g., the UE 120 may monitor PDCCH candidates for DCI 560, which schedules PUSCH communication 565). Additionally, or alternatively, a default behavior of direction may be specified by an RRC parameter that semi-statically indicates the downlink or uplink direction to the UE 120. The RRC parameter may involve dedicated RRC signaling or re-use of RRC signaling, such as a TDD-ULDL-dedicated parameter.

Examples 520 and 530 relate to time-domain collisions between conflicting transmissions or receptions in SBFD symbols. As shown in example 520, a time-domain collision may occur due to lack of a sufficient timeline for switching between reception and transmission (e.g., an overlap based at least in part on physical time). For example, a downlink PDCCH communication 570 and an uplink SRS 575 may be scheduled with insufficient time to switch from reception (for the downlink PDCCH communication 570) to transmission (for the uplink SRS 575). As shown in example 530, a time-domain collision may occur due to overlap, for at least one OFDM symbol, of a downlink transmission (e.g., an SPS-PDSCH communication 580) and an uplink transmission (e.g., a PUCCH communication 585).

Therefore, as demonstrated by examples 520 and 530, SBFD may call for resolution of time-domain collision rules that account for conflicting time-domain collisions between transmissions and receptions. For example, the collisions may be handled by re-using certain collision handling rules and/or introducing additional collision handling rules that relax (e.g., account for) scenarios that were not previously allowed (e.g., scenarios that the UE 120 does not expect). For example, the UE 120 may not expect to be configured by higher layers for an uplink transmission and a downlink reception (e.g., where the uplink transmission at least partially overlaps with the downlink reception or where the UE 120 has insufficient time to switch between reception and transmission). Additionally, or alternatively, semi-static uplink (and downlink) may not be allowed in symbols having conflicting directions (e.g., SRS in downlink symbols).

As indicated above, FIG. 5 is provided as an example. Other examples may differ from what is described with respect to FIG. 5.

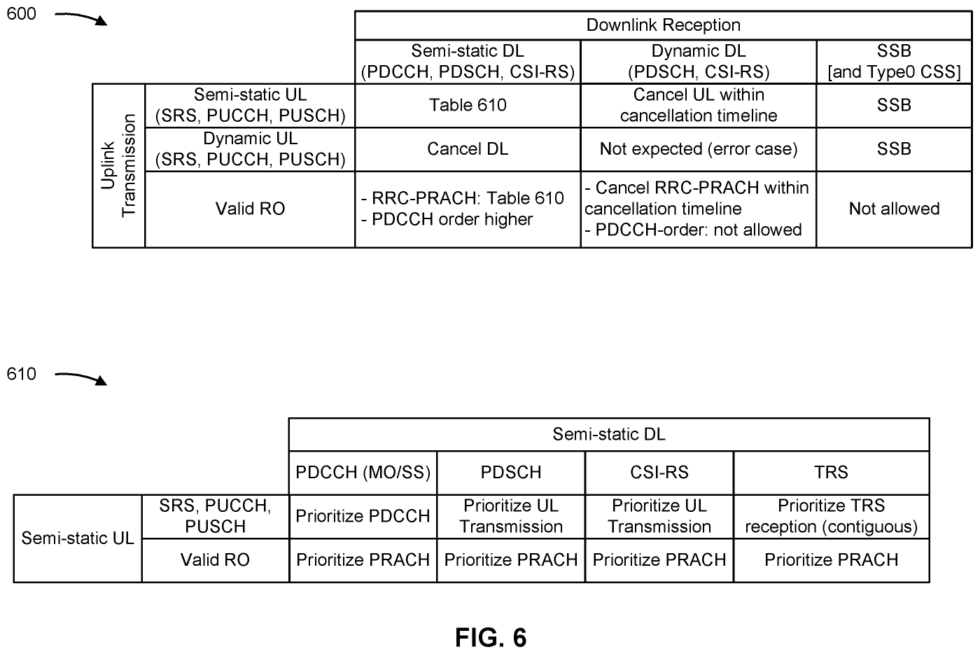

FIG. 6 is a diagram illustrating tables 600 and 610 summarizing collision handling rules for non-transparent SBFD operation, in accordance with the present disclosure. The collision handling rules (e.g., for SBFD collisions) may exist because the UE 120 may determine whether to transmit or receive during SBFD slots. For example, a UE 120 may apply one or more of the rules to resolve time-domain collisions in SBFD symbols. In some examples, the UE 120 may be an SBFD-aware half-duplex UE. For example, the UE 120 may be configured with uplink subbands within downlink symbols. As a result, the UE 120 may determine whether transmission or reception should be specified in SBFD symbols based at least in part on collision handling rules for flexible symbols.

Table 600 summarizes rules for handling of collisions between a downlink reception and an uplink transmission in an SBFD symbol. Examples of the downlink reception may include semi-static downlink receptions (e.g., PDCCH communications, PDSCH communications, CSI-RSs, or the like), dynamic downlink receptions (e.g., PDSCH communications, CSI-RSs, or the like), or SSB and Type 0 common search space (CSS) receptions. Examples of the uplink transmission may include semi-static uplink transmissions (e.g., SRSs, PUCCH communications, PUSCH communications, or the like), dynamic uplink transmissions (e.g., SRSs, PUCCH communications, PUSCH communications, or the like), or a valid random access channel (RACH) occasion (RO) (e.g., for validation of ROs in downlink symbols).

Table 610 summarizes rules for handling of collisions between semi-static downlink receptions and semi-static uplink transmission. Examples of semi-static downlink receptions may include PSCCH communications (e.g., MO or SS communications), PDSCH communications, CSI-RS communications, TRSs, or the like. Examples of semi-static uplink transmissions may include SRSs, PUCCH communications, PUSCH communications, valid ROs, or the like. As shown, generally, uplink transmissions may be prioritized for coverage and latency. However, PDCCH MOs and TRSs may be prioritized over semi-static PUSCH communications. For example, in certain cases, PUSCH occasions may be dropped due to collisions with PDCCH MOs or TRSs.

Additionally, or alternatively, a priority rule configured by a network node 110 may resolve such collisions. In some examples, the priority rule may prioritize high-priority (HP) communications over low-priority (LP) communications. In some examples, the priority rule may prioritize semi-persistent communications over periodic communications.

As indicated above, FIG. 6 is provided as an example. Other examples may differ from what is described with respect to FIG. 6.

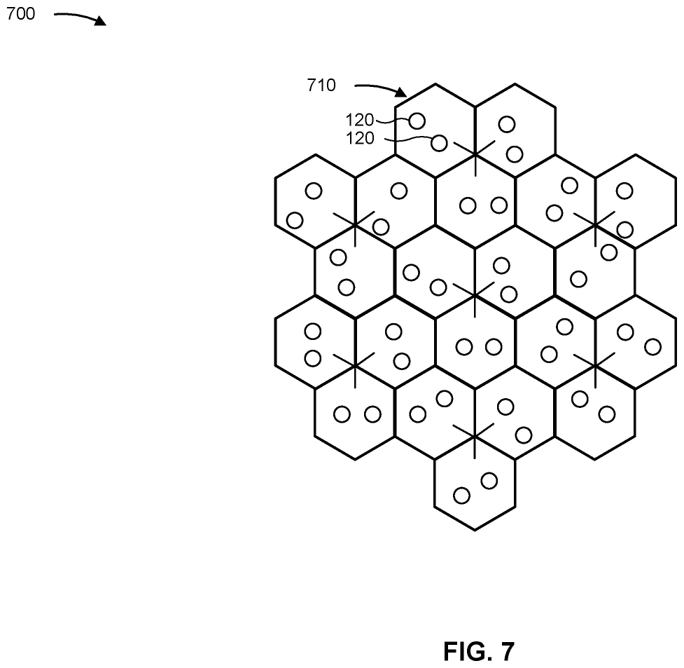

FIG. 7 is a diagram illustrating an example 700 of SBFD coverage gain in an urban microcellular (UMa) environment with UE clustering, in accordance with the present disclosure.

As shown, multiple UEs 120 may be clustered within the same cell 710. In some examples, SBFD may improve signal levels for the clustered UEs 120 (e.g., to 53 dBm). For example, SBFD may improve uplink coverage in terms of maximum pathloss (MPL) compared to TDD. For example, SBFD-aware UEs experiencing different levels of cross-link interference (CLI) may outperform a TDD-capable UE under low-, medium-, and high-load conditions. Furthermore, SBFD may improve median uplink user perceived throughput (UPT) for small packets in the UMa environment compare to TDD. For example, the SBFD-aware UEs may achieve at least a 2.8-fold improvement in UPT over the TDD-capable UE.

As indicated above, FIG. 7 is provided as an example. Other examples may differ from what is described with respect to FIG. 7.

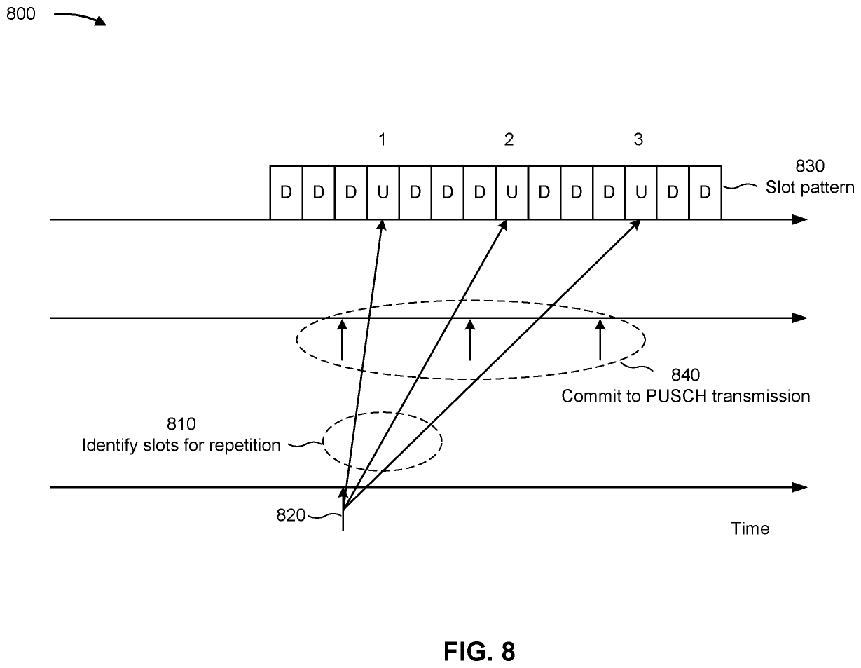

FIG. 8 is a diagram illustrating an example 800 of a two-step procedure for counting repetitions, in accordance with the present disclosure. The two-step procedure may be referred to as “available slot counting” and may apply to the unpaired spectrum, the paired spectrum, supplementary uplink (SUL), or the like.

As shown by reference number 810, at a first time 820, the UE 120 may identify slots, in a slot pattern 830, for repetition (e.g., PUSCH repetition). For example, in a first step, the UE 120 may determine K available slots, in the slot pattern 830, for K repetitions. A slot may be considered to be available if all of the symbols contained in the TDRA for the slot are uplink or flexible symbols (e.g., as indicated by a tdd-UL-DL-ConfigurationCommon parameter and/or a tdd-UL-DL-ConfigurationDedicated parameter) and are not used for SSB transmission (e.g., as per an SSBPositionsInBurst parameter).

As shown by reference number 820, at second times 840, a UE 120 may commit to a PUSCH transmission. For example, in a second step, the UE 120 may determine whether to drop a PUSCH repetition according to one or more PUSCH dropping rules. Unlike the first step (which may be based at least in part on semi-static configurations), the second step may account for dynamic events (e.g., dynamic slot format information (SFI), grants for higher-priority channels, or the like). As a result, the second step may help to ensure robustness in case the UE 120 misses DCI. For example, even if the UE 120 misses the DCI, the UE 120 and the network node 110 may remain synchronized on the available slots.

The UE 120 may not revisit the set of slots identified in the first step even in the event of a cancellation of a PUSCH repetition. For example, the PUSCH repetition may be counted in the K repetitions regardless of whether the PUSCH repetition is dropped or canceled. Each slot identified in the first step may be considered a transmission occasion for PUSCH repetition, and the redundancy version (RV) may be cycled across transmission occasions irrespective of whether the PUSCH transmission in the transmission occasion is omitted. In some examples, if a transmission on an available slot is dropped or cancelled, then that transmission may not be replaced.

Additionally, or alternatively, available slots may be determined for PUCCH. PUCCH repetition may be based at least in part on available slot counting from a reference slot. The reference slot may be determined based at least in part on one or more RRC parameters (e.g., a periodic PUCCH (P-PUCCH) communication for a scheduling request (SR) or CSI-Reporting) or a K1 parameter from a triggering DCI (e.g., for acknowledgment/negative acknowledgment (A/N) PUCCH communications).

For PUCCH repetitions in the unpaired spectrum, the UE 120 may determine N_{PUCCH}^{repeat} slots for a PUCCH transmission starting from a slot indicated to the UE 120 for hybrid automatic repeat request acknowledgment (HARQ-ACK) reporting or a slot determined for SR reporting or for CSI reporting. The slot determined for SR reporting or for CSI reporting may have an uplink symbol or a flexible symbol that is not a synchronization signal or physical broadcast channel (SS/PBCH) block symbol provided by a startingSymbolIndex parameter as a first symbol. The slot determined for SR reporting or for CSI reporting (e.g., an available slot for PUCCH) may also have consecutive uplink symbols or flexible symbols that are not SS/PBCH block symbols, starting from the first symbol, equal to or larger than a quantity of symbols provided by an nrofsymbols parameter (e.g., for PUCCH). If the UE 120 determines that, for a repetition of a PUCCH transmission in a slot, the quantity of symbols available for the PUCCH transmission is smaller than the value provided by the nrofSymbols parameter for the corresponding PUCCH format, then the UE 120 may not transmit the PUCCH repetition in the slot.

Additionally, or alternatively, available slots may be determined for CG TBoMS. For TBoMS with available slots, for the unpaired spectrum, the UE 120 may determine N·K slots for a PUSCH transmission of TBoMS with a type 2 CG activated by DCI format 0_1 or 0_2. The UE 120 may determine the N·K slots based at least in part on the tdd-UL-DL-ConfigurationCommon parameter, the tdd-UL-DL-ConfigurationDedicated parameter, the SSBPositionsInBurst parameter, and/or the TDRA information field value in the DCI format 0_1 or 0_2. A slot may not be counted in the number of N·K slots for a PUSCH transmission of TBoMS with a type 2 CG activated by DCI format 0_1 or 0_2 if at least one of the symbols indicated by an indexed row of a used resource allocation table in the slot overlaps with a downlink symbol indicated by the tdd-UL-DL-ConfigurationCommon parameter or the tdd-UL-DL-ConfigurationDedicated parameter, if provided, or a symbol of an SS/PBCH block with an index provided by the SSBPositionsInBurst parameter.

For type 2 PUSCH transmissions with a CG of TBoMS, the UE 120 may transmit the TB across the N·K slots determined for the PUSCH transmission applying the same symbol allocation in each slot. In some cases, a type 2 PUSCH transmission with a CG of TBoMS may be omitted in a slot.

As indicated above, FIG. 8 is provided as an example. Other examples may differ from what is described with respect to FIG. 8.

Uplink/downlink collision handling rules may be defined to determine whether a half-duplex UE (e.g., UE 120) is to perform transmission or reception in SBFD scenarios. For example, in some SBFD collision handling cases, PUSCH occasions that collide with semi-static downlink TRS or PDCCH MOs may be dropped. Such semi-static collisions are a relatively recent development because SBFD is an emerging technology. SBFD collision rules (e.g., the rule dictating that PUSCH occasions that collide with semi-static downlink TRS or PDCCH MOs are to be dropped) may exist because of the nature of downlink and uplink transmissions coinciding at certain times.

Although some coverage enhancements, such as available slot counting, have been introduced, PUSCH occasions that are dropped due to SBFD collision rules have not been accounted for with respect to available slot counting. For example, whether to count PUSCH occasions that are dropped due to collisions with TRSs or PDCCH MOs toward repetitions is unresolved. Counting these semi-static dropped PUSCH or PUCCH communications toward repetitions may use excessive UE resources (e.g., processing or computing resources).

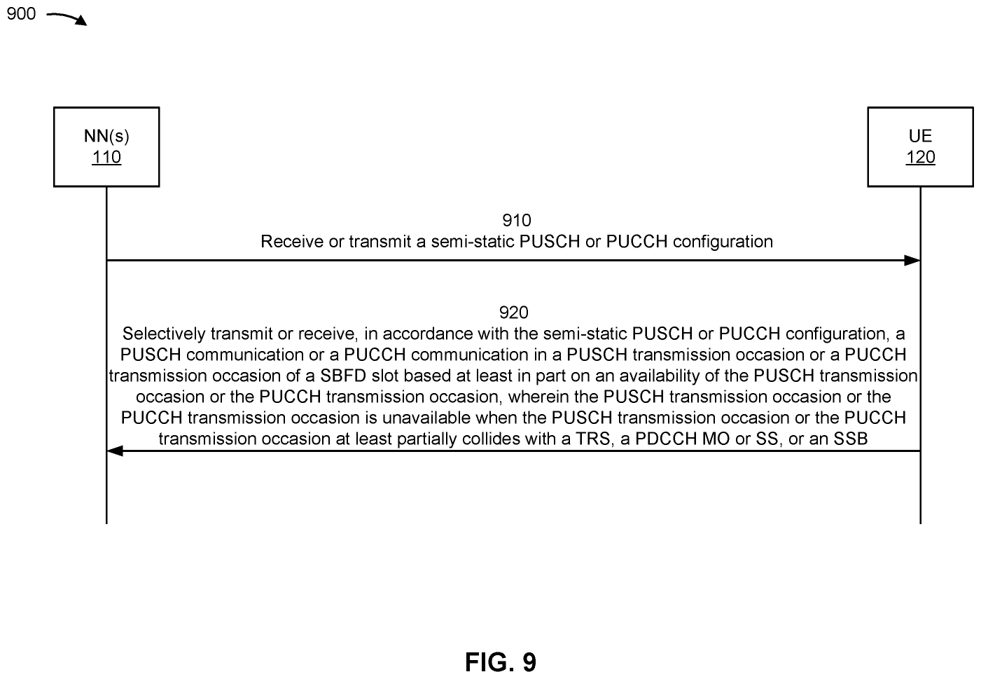

FIG. 9 is a diagram illustrating an example 900 associated with transmission occasion availability based at least in part on SBFD collisions, in accordance with the present disclosure. As shown in FIG. 9, a network node 110 and a UE 120 may communicate with one another.

As shown by reference number 910, the network node 110 may transmit, and the UE 120 may receive, a semi-static PUSCH or PUCCH configuration. In some examples, the network node 110 may transmit, and the UE 120 may receive, the semi-static PUSCH or PUCCH configuration with repetition or TBoMS. For example, the semi-static PUSCH or PUCCH configuration may configure repetition or TBoMS.

As shown by reference number 920, the UE 120 may selectively transmit, and the network node 110 may selectively receive, a PUSCH communication or a PUCCH communication in accordance with the semi-static PUSCH or PUCCH configuration. For example, the PUSCH communication or the PUCCH communication may be configured by the semi-static PUSCH or PUCCH configuration. The UE 120 may selectively transmit, and the network node 110 may selectively receive, a PUSCH transmission occasion or a PUCCH transmission occasion of a sub-band full duplex (SBFD) slot based at least in part on an availability of the PUSCH transmission occasion or the PUCCH transmission occasion. For example, if the PUSCH or PUCCH transmission occasion is unavailable (e.g., invalid), then the UE 120 may refrain from transmitting, and the network node 110 may refrain from receiving, the PUSCH communication or the PUCCH communication. If the PUSCH or PUCCH transmission occasion is available (e.g., valid), then the UE 120 may transmit, and the network node 110 may receive, the PUSCH communication or the PUCCH communication.

Whether the PUSCH transmission occasion or the PUCCH transmission occasion is unavailable may be based at least in part on whether the transmission occasion PUSCH or the PUCCH transmission occasion at least partially collides with a TRS, a PDCCH MO or SS, or an SSB. For example, the PUSCH transmission occasion or the PUCCH transmission occasion may be unavailable when the transmission occasion PUSCH or the PUCCH transmission occasion at least partially collides with the TRS, the PDCCH MO or SS, or the SSB. The PUSCH transmission occasion or the PUCCH transmission occasion may be available if the PUSCH or PUCCH transmission occasion does not at least partially collide with the TRS, the PDCCH MO or SS, or the SSB. In some examples, the PUSCH or PUCCH transmission occasion may at least partially collide with the TRS, the PDCCH MO or SS, or the SSB if at least one symbol of the PUSCH or PUCCH transmission occasion overlaps with at least one symbol of the TRS, the PDCCH MO or SS, or the SSB.

In some aspects, the PUSCH transmission occasion or the PUCCH transmission occasion may at least partially collide with the TRS, the PDCCH MO or SS, or the SSB when at least one symbol of a TDRA associated with the PUSCH or PUCCH transmission occasion collides with the TRS, the PDCCH MO or SS, or the SSB. For example, the first step of the two-step procedure for available slot counting may be modified. For example, in the modified first step, the UE 120 may determine K available slots for K repetitions. A slot may be considered to be available if all of the symbols contained in the TDRA for the slot are uplink or flexible symbols (e.g., as indicated by a tdd-UL-DL-ConfigurationCommon parameter and/or a tdd-UL-DL-ConfigurationDedicated parameter), are not used for SSB transmission (e.g., as per an SSBPositionsInBurst parameter), and do not collide with the TRS, the PDCCH MO or SS, or the SSB. In this example, in the second step for available slot counting, the UE 120 may determine whether to drop a PUSCH repetition according to one or more PUSCH dropping rules, but the PUSCH repetition may be counted in the K repetitions regardless of whether the PUSCH repetition is dropped or canceled.

In some aspects, the UE 120 may selectively transmit, and the network node 110 may selectively receive, the PUSCH communication or the PUCCH communication based at least in part on whether the PUSCH communication or the PUCCH communication is dropped due to a collision between: the PUSCH transmission occasion or the PUCCH transmission occasion; and the TRS, the PDCCH MO or SS, or the SSB. For example, the second step of the two-step procedure for available slot counting may be updated. In this example, in the first step of the two-step procedure for available slot counting, the UE 120 may determine K available slots for K repetitions. A slot may be considered to be available if all of the symbols contained in the TDRA for the slot are uplink or flexible symbols (e.g., as indicated by a tdd-UL-DL-Configuration Common parameter and/or a tdd-UL-DL-ConfigurationDedicated parameter) and are not used for SSB transmission (e.g., as per an SSBPositionsInBurst parameter). In the updated second step of the two-step procedure for available slot counting, the UE 120 may determine whether to drop a PUSCH repetition according to one or more PUSCH dropping rules, including SBFD dropping rules that prompt the UE 120 to drop a PUSCH repetition due to a collision with the TRS, the PDCCH MO or SS, or the SSB. The PUSCH repetition may be counted in the K repetitions regardless of whether the PUSCH repetition is dropped or canceled.

In some aspects, the PUSCH communication may be transmitted in the PUSCH transmission occasion when the PUSCH transmission occasion is available. For example, the UE 120 may transmit, and the network node 110 may selectively, the PUSCH communication in the PUSCH transmission occasion. In some examples, the PUSCH communication may be a PUSCH repetition.

In some aspects, the PUSCH communication may be a CG PUSCH communication associated with TBoMS. The CG PUSCH communication may be associated with TBoMS in that the CG PUSCH communication may be used to transmit a TB over multiple slots. In some examples, the modified first step or the updated second step of the two-step procedure for available slot counting may be extended to TBoMS in CG-PUSCH (e.g., to CG-PUSCH with TBoMS). For example, N·K slots for TBoMS on type 2 CG-PUSCH may be determined by excluding slots with a TRS (e.g., a periodic TRS (P-TRS)), PDCCH MO or SS, or SSB that overlaps in time with CG-PUSCH. Thus, slots with P-TRS or PDCCH overlapping in time with CG-PUSCH may not counted in TBoMS.

In some aspects, the PUCCH communication may be transmitted in the PUCCH transmission occasion when the PUCCH transmission occasion is available. For example, the UE 120 may transmit, and the network node 110 may receive, the PUCCH communication in the PUCCH transmission occasion. In some examples, the PUCCH communication may be a PUCCH repetition.

In some aspects, the TRS may be associated with a P-TRS occasion (e.g., any P-TRS occasion). The TRS may be associated with the P-TRS occasion in that the TRS may be scheduled for transmission in the P-TRS occasion. In some examples, whether the PUSCH or PUCCH transmission occasion is unavailable may be based at least in part on whether the PUSCH or PUCCH transmission occasion at least partially collides with the TRS. In some aspects, the TRS, the PDCCH MO or SS, or the SSB may be the PDCCH MO (e.g., any PDCCH MO). For example, whether the PUSCH or PUCCH transmission occasion is unavailable may be based at least in part on whether the PUSCH or PUCCH transmission occasion at least partially collides with the PDCCH MO.

In some aspects, the UE 120 may selectively transmit, and the network node 110 may selectively receive, the PUSCH communication or the PUCCH communication based at least in part on whether the PUSCH transmission occasion or the PUCCH transmission occasion at least partially collides with two initial symbols in a TRS occasion associated with the TRS. The TRS occasion may be associated with the TRS in that the TRS may be scheduled for transmission in the TRS occasion. In some examples, whether the PUSCH or PUCCH transmission occasion is unavailable may be based at least in part on whether the PUSCH or PUCCH transmission occasion at least partially collides with the two initial symbols in the TRS occasion (e.g., a first TRS slot).

In some aspects, the PDCCH MO or SS may be a control resource set (CORESET) 0 or CSS. For example, whether the PUSCH or PUCCH transmission occasion is unavailable may be based at least in part on whether the PUSCH or PUCCH transmission occasion at least partially collides with the CORESET 0 or CSS.

As indicated above, FIG. 9 is provided as an example. Other examples may differ from what is described with respect to FIG. 9.

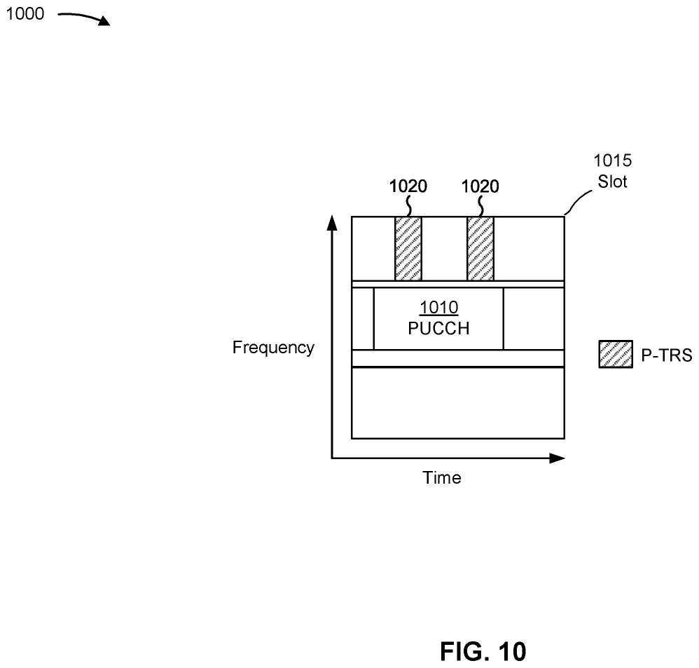

FIG. 10 is a diagram illustrating an example 1000 associated with available slot determinations for PUCCH repetitions, in accordance with the present disclosure.

In example 1000, a PUCCH transmission occasion 1010 in a slot 1015 may at least partially overlap P-TRS occasions 1020. As a result, the slot 1015 may be unavailable for transmission of a PUCCH repetition associated with the PUCCH transmission occasion 1010. Therefore, the PUCCH repetition may not be transmitted because of the P-TRS, and the slot 1015 may be excluded.

In other examples, a PUCCH transmission occasion may at least partially overlap one or more PDCCH MOs in a slot. As a result, the slot may be unavailable for transmission of a PUCCH repetition associated with the PUCCH transmission occasion. Therefore, the PUCCH repetition may not be transmitted because of the PDCCH MO(s), and the slot may be excluded.

As indicated above, FIG. 10 is provided as an example. Other examples may differ from what is described with respect to FIG. 10.

Selectively transmitting or receiving, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with the TRS, the PDCCH MO or SS, or the SSB, may account for SBFD collision rules for purposes of available slot counting (e.g., counting PUSCH or PUCCH transmission occasions for repetition, TBoMS, or the like). For example, the UE 120 may avoid counting semi-static dropped PUSCH or PUCCH communications, thereby reducing UE resources (e.g., processing or computing resources) occupied by available slot counting and/or further increasing coverage under SBFD.

The PUSCH transmission occasion or the PUCCH transmission occasion at least partially colliding with the TRS, the PDCCH MO or SS, or the SSB when at least one symbol of the TDRA associated with the PUSCH or PUCCH transmission occasion collides with the TRS, the PDCCH MO or SS, or the SSB, may enable the UE 120 to avoid counting a slot that the UE 120 will later drop, thereby further conserving UE resources.

Selectively transmitting or receiving the PUSCH communication or the PUCCH communication based at least in part on whether the PUSCH transmission occasion or the PUCCH transmission occasion at least partially collides with two initial symbols in a TRS occasion associated with the TRS may enable prioritization of the TRS in a first TRS slot and prioritization of the uplink transmission in subsequent TRS slots. The TRS, the PDCCH MO or SS, or the SSB being the PDCCH MO or SS, and the PDCCH MO or SS being a CORESET 0 or CSS, may enable prioritization of a CORESET 0 or CSS, which may contain important scheduling information.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with availability of transmission occasions based on SBFD collisions.

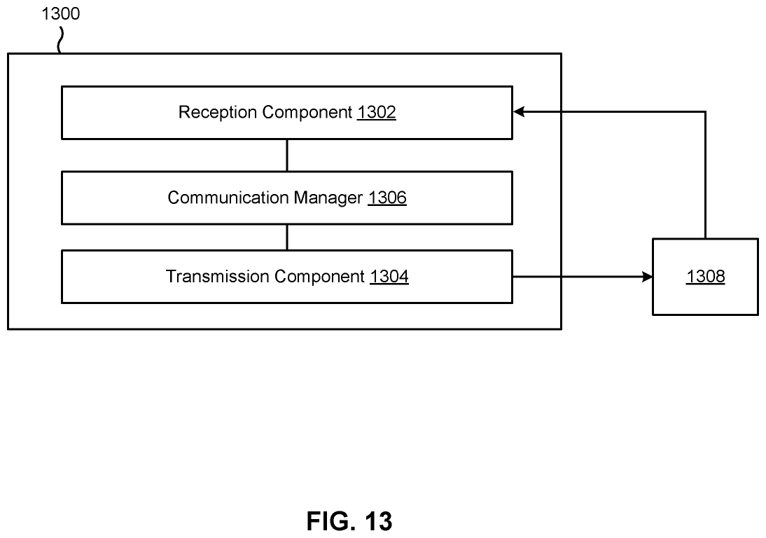

As shown in FIG. 11, in some aspects, process 1100 may include receiving a semi-static PUSCH or PUCCH configuration (block 1110). For example, the UE (e.g., using reception component 1302 and/or communication manager 1306, depicted in FIG. 13) may receive a semi-static PUSCH or PUCCH configuration, as described above.

As further shown in FIG. 11, in some aspects, process 1100 may include selectively transmitting, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB (block 1120). For example, the UE (e.g., using transmission component 1304 and/or communication manager 1306, depicted in FIG. 13) may selectively transmit, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB, as described above.

Process 1100 may include additional aspects, such as any single aspect or any combination of aspects described below and/or in connection with one or more other processes described elsewhere herein.

In a first aspect, the PUSCH transmission occasion or the PUCCH transmission occasion at least partially collides with the TRS, the PDCCH MO or SS, or the SSB when at least one symbol of a TDRA associated with the PUSCH transmission occasion or the PUCCH transmission occasion collides with the TRS, the PDCCH MO or SS, or the SSB.

In a second aspect, alone or in combination with the first aspect, selectively transmitting the PUSCH communication or the PUCCH communication includes selectively transmitting the PUSCH communication or the PUCCH communication based at least in part on whether the PUSCH communication or the PUCCH communication is dropped due to a collision between the PUSCH transmission occasion or the PUCCH transmission occasion, and the TRS, the PDCCH MO or SS, or the SSB.

In a third aspect, alone or in combination with one or more of the first and second aspects, the PUSCH communication is transmitted in the PUSCH transmission occasion when the PUSCH transmission occasion is available.

In a fourth aspect, alone or in combination with one or more of the first through third aspects, the PUSCH communication is a CG PUSCH communication associated with TBoMS.

In a fifth aspect, alone or in combination with one or more of the first through fourth aspects, the PUCCH communication is transmitted in the PUCCH transmission occasion when the PUCCH transmission occasion is available.

In a sixth aspect, alone or in combination with one or more of the first through fifth aspects, the TRS is associated with a P-TRS occasion.

In a seventh aspect, alone or in combination with one or more of the first through sixth aspects, selectively transmitting the PUSCH communication or the PUCCH communication includes selectively transmitting the PUSCH communication or the PUCCH communication based at least in part on whether the PUSCH transmission occasion or the PUCCH transmission occasion at least partially collides with two initial symbols in a TRS occasion associated with the TRS.

In an eighth aspect, alone or in combination with one or more of the first through seventh aspects, the PDCCH MO or SS is a CORESET 0 or CSS.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with availability of transmission occasions based on SBFD collisions.

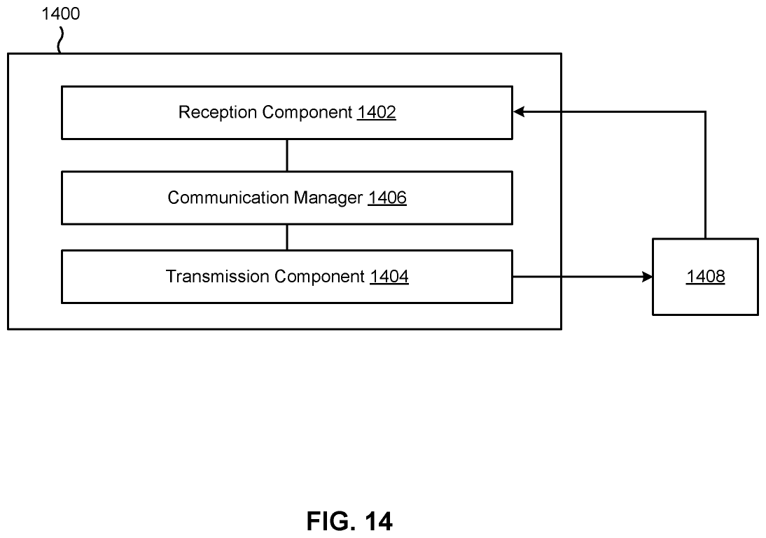

As shown in FIG. 12, in some aspects, process 1200 may include transmitting a semi-static PUSCH or PUCCH configuration (block 1210). For example, the network node (e.g., using transmission component 1404 and/or communication manager 1406, depicted in FIG. 14) may transmit a semi-static PUSCH or PUCCH configuration, as described above.

As further shown in FIG. 12, in some aspects, process 1200 may include selectively receiving, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB (block 1220). For example, the network node (e.g., using reception component 1402 and/or communication manager 1406, depicted in FIG. 14) may selectively receive, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB, as described above.

Process 1200 may include additional aspects, such as any single aspect or any combination of aspects described below and/or in connection with one or more other processes described elsewhere herein.

In a first aspect, the PUSCH transmission occasion or the PUCCH transmission occasion at least partially collides with the TRS, the PDCCH MO or SS, or the SSB when whether at least one symbol of a TDRA associated with the PUSCH transmission occasion or the PUCCH transmission occasion collides with the TRS, the PDCCH MO or SS, or the SSB.

In a second aspect, alone or in combination with the first aspect, selectively receiving the PUSCH communication or the PUCCH communication includes selectively receiving the PUSCH communication or the PUCCH communication based at least in part on whether the PUSCH communication or the PUCCH communication is dropped due to a collision between the PUSCH transmission occasion or the PUCCH transmission occasion, and the TRS, the PDCCH MO or SS, or the SSB.

In a third aspect, alone or in combination with one or more of the first and second aspects, the PUSCH communication is transmitted in the PUSCH transmission occasion when the PUSCH transmission occasion is available.

In a fourth aspect, alone or in combination with one or more of the first through third aspects, the PUSCH communication is a CG PUSCH communication associated with TBoMS.

In a fifth aspect, alone or in combination with one or more of the first through fourth aspects, the PUCCH communication is transmitted in the PUCCH transmission occasion when the PUCCH transmission occasion is available.

In a sixth aspect, alone or in combination with one or more of the first through fifth aspects, the TRS is associated with a P-TRS occasion.

In a seventh aspect, alone or in combination with one or more of the first through sixth aspects, selectively receiving the PUSCH communication or the PUCCH communication includes selectively receiving the PUSCH communication or the PUCCH communication based at least in part on whether the PUSCH transmission occasion or the PUCCH transmission occasion at least partially collides with two initial symbols in a TRS occasion associated with the TRS.

In an eighth aspect, alone or in combination with one or more of the first through seventh aspects, the PDCCH MO or SS is a CORESET 0 or CSS.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 9 and 10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a PUSCH or PUCCH configuration. The transmission component 1304 may selectively transmit, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 9 and 10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit a semi-static PUSCH or PUCCH configuration. The reception component 1402 may selectively receive, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: receiving a semi-static PUSCH or PUCCH configuration; and selectively transmitting, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB.

Aspect 2: The method of Aspect 1, wherein the PUSCH transmission occasion or the PUCCH transmission occasion at least partially collides with the TRS, the PDCCH MO or SS, or the SSB when at least one symbol of a TDRA associated with the PUSCH transmission occasion or the PUCCH transmission occasion collides with the TRS, the PDCCH MO or SS, or the SSB.

Aspect 3: The method of any of Aspects 1-2, wherein selectively transmitting the PUSCH communication or the PUCCH communication includes selectively transmitting the PUSCH communication or the PUCCH communication based at least in part on whether the PUSCH communication or the PUCCH communication is dropped due to a collision between: the PUSCH transmission occasion or the PUCCH transmission occasion, and the TRS, the PDCCH MO or SS, or the SSB.

Aspect 4: The method of any of Aspects 1-3, wherein the PUSCH communication is transmitted in the PUSCH transmission occasion when the PUSCH transmission occasion is available.

Aspect 5: The method of Aspect 4, wherein the PUSCH communication is a CG PUSCH communication associated with TBoMS.

Aspect 6: The method of any of Aspects 1-5, wherein the PUCCH communication is transmitted in the PUCCH transmission occasion when the PUCCH transmission occasion is available.

Aspect 7: The method of any of Aspects 1-6, wherein the TRS is associated with a P-TRS occasion.

Aspect 8: The method of any of Aspects 1-7, wherein selectively transmitting the PUSCH communication or the PUCCH communication includes selectively transmitting the PUSCH communication or the PUCCH communication based at least in part on whether the PUSCH transmission occasion or the PUCCH transmission occasion at least partially collides with two initial symbols in a TRS occasion associated with the TRS.

Aspect 9: The method of any of Aspects 1-8, wherein the PDCCH MO or SS is a CORESET 0 or CSS.

Aspect 10: A method of wireless communication performed by a network node, comprising: transmitting a semi-static PUSCH or PUCCH configuration; and selectively receiving, in accordance with the semi-static PUSCH or PUCCH configuration, a PUSCH communication or a PUCCH communication in a PUSCH transmission occasion or a PUCCH transmission occasion of an SBFD slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a TRS, a PDCCH MO or SS, or an SSB B.

Aspect 11: The method of Aspect 10, the PUSCH transmission occasion or the PUCCH transmission occasion at least partially collides with the TRS, the PDCCH MO or SS, or the SSB when at least one symbol of a TDRA associated with the PUSCH transmission occasion or the PUCCH transmission occasion collides with the TRS, the PDCCH MO or SS, or the SSB.

Aspect 12: The method of any of Aspects 10-11, wherein selectively receiving the PUSCH communication or the PUCCH communication includes selectively receiving the PUSCH communication or the PUCCH communication based at least in part on whether the PUSCH communication or the PUCCH communication is dropped due to a collision between: the PUSCH transmission occasion or the PUCCH transmission occasion, and the TRS, the PDCCH MO or SS, or the SSB.

Aspect 13: The method of any of Aspects 10-12, wherein the PUSCH communication is transmitted in the PUSCH transmission occasion when the PUSCH transmission occasion is available.

Aspect 14: The method of Aspect 13, wherein the PUSCH communication is a CG PUSCH communication associated with TBoMS.

Aspect 15: The method of any of Aspects 10-14, wherein the PUCCH communication is transmitted in the PUCCH transmission occasion when the PUCCH transmission occasion is available.

Aspect 16: The method of any of Aspects 10-15, wherein the TRS is associated with a P-TRS occasion.

Aspect 17: The method of any of Aspects 10-16, wherein selectively receiving the PUSCH communication or the PUCCH communication includes selectively receiving the PUSCH communication or the PUCCH communication based at least in part on whether the PUSCH transmission occasion or the PUCCH transmission occasion at least partially collides with two initial symbols in a TRS occasion associated with the TRS.

Aspect 18: The method of any of Aspects 10-17, wherein the PDCCH MO or SS is a CORESET 0 or CSS.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a semi-static physical uplink shared channel (PUSCH) or physical uplink control channel (PUCCH) configuration; and
selectively transmit, in accordance with the semi-static PUSCH or PUCCH configuration, a PUSCH communication or a PUCCH communication in a PUSCH transmission occasion or a PUCCH transmission occasion of a sub-band full duplex (SBFD) slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a tracking reference signal (TRS), a physical downlink control channel (PDCCH) monitoring occasion (MO) or search space (SS), or a synchronization signal block (SSB).

2. The apparatus of claim 1, wherein the PUSCH transmission occasion or the PUCCH transmission occasion at least partially collides with the TRS, the PDCCH MO or SS, or the SSB when at least one symbol of a time domain resource allocation (TDRA) associated with the PUSCH transmission occasion or the PUCCH transmission occasion collides with the TRS, the PDCCH MO or SS, or the SSB.

3. The apparatus of claim 1, wherein the one or more processors, to cause the UE to selectively transmit the PUSCH communication or the PUCCH communication, are configured to cause the UE to selectively transmit the PUSCH communication or the PUCCH communication based at least in part on whether the PUSCH communication or the PUCCH communication is dropped due to a collision between:
the PUSCH transmission occasion or the PUCCH transmission occasion, and
the TRS, the PDCCH MO or SS, or the SSB.

4. The apparatus of claim 1, wherein the PUSCH communication is transmitted in the PUSCH transmission occasion when the PUSCH transmission occasion is available.

5. The apparatus of claim 4, wherein the PUSCH communication is a configured grant (CG) PUSCH communication associated with transport block (TB) processing over multiple slots (TBoMS).

6. The apparatus of claim 1, wherein the PUCCH communication is transmitted in the PUCCH transmission occasion when the PUCCH transmission occasion is available.

7. The apparatus of claim 1, wherein the TRS is associated with a periodic TRS (P-TRS) occasion.

8. The apparatus of claim 1, wherein the one or more processors, to cause the UE to selectively transmit the PUSCH communication or the PUCCH communication, are configured to cause the UE to selectively transmit the PUSCH communication or the PUCCH communication based at least in part on whether the PUSCH transmission occasion or the PUCCH transmission occasion at least partially collides with two initial symbols in a TRS occasion associated with the TRS.

9. The apparatus of claim 1, wherein the PDCCH MO or SS is a control resource set (CORESET) 0 or common search space (CSS).

10. An apparatus for wireless communication at a network node, comprising:
one or more memories; and
one or more processors, coupled to the one or more memories, configured to cause the network node to:
transmit a semi-static physical uplink shared channel (PUSCH) or physical uplink control channel (PUCCH) configuration; and
selectively receive, in accordance with the semi-static PUSCH or PUCCH configuration, a PUSCH communication or a PUCCH communication in a PUSCH transmission occasion or a PUCCH transmission occasion of a sub-band full duplex (SBFD) slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a tracking reference signal (TRS), a physical downlink control channel (PDCCH) monitoring occasion (MO) or search space (SS), or a synchronization signal block (SSB).

11. The apparatus of claim 10, wherein the PUSCH transmission occasion or the PUCCH transmission occasion at least partially collides with the TRS, the PDCCH MO or SS, or the SSB when at least one symbol of a time domain resource allocation (TDRA) associated with the PUSCH transmission occasion or the PUCCH transmission occasion collides with the TRS, the PDCCH MO or SS, or the SSB.

12. The apparatus of claim 10, wherein the one or more processors, to cause the network node to selectively receive the PUSCH communication or the PUCCH communication, are configured to cause the network node to selectively receive the PUSCH communication or the PUCCH communication based at least in part on whether the PUSCH communication or the PUCCH communication is dropped due to a collision between:
the PUSCH transmission occasion or the PUCCH transmission occasion, and
the TRS, the PDCCH MO or SS, or the SSB.

13. The apparatus of claim 10, wherein the PUSCH communication is transmitted in the PUSCH transmission occasion when the PUSCH transmission occasion is available.

14. The apparatus of claim 13, wherein the PUSCH communication is a configured grant (CG) PUSCH communication associated with transport block (TB) processing over multiple slots (TBoMS).

15. The apparatus of claim 10, wherein the PUCCH communication is transmitted in the PUCCH transmission occasion when the PUCCH transmission occasion is available.

16. The apparatus of claim 10, wherein the TRS is associated with a periodic TRS (P-TRS) occasion.

17. The apparatus of claim 10, wherein the one or more processors, to cause the network node to selectively receive the PUSCH communication or the PUCCH communication, are configured to cause the network node to selectively receive the PUSCH communication or the PUCCH communication based at least in part on whether the PUSCH transmission occasion or the PUCCH transmission occasion at least partially collides with two initial symbols in a TRS occasion associated with the TRS.

18. The apparatus of claim 10, wherein the PDCCH MO or SS is a control resource set (CORESET) 0 or common search space (CSS).

19. A method of wireless communication performed by a user equipment (UE), comprising:
receiving a semi-static physical uplink shared channel (PUSCH) or physical uplink control channel (PUCCH) configuration; and
selectively transmitting, in accordance with the semi-static PUSCH or PUCCH configuration, a PUSCH communication or a PUCCH communication in a PUSCH transmission occasion or a PUCCH transmission occasion of a sub-band full duplex (SBFD) slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a tracking reference signal (TRS), a physical downlink control channel (PDCCH) monitoring occasion (MO) or search space (SS), or a synchronization signal block (SSB).

20. The method of claim 19, wherein the PUSCH transmission occasion or the PUCCH transmission occasion at least partially collides with the TRS, the PDCCH MO or SS, or the SSB when at least one symbol of a time domain resource allocation (TDRA) associated with the PUSCH transmission occasion or the PUCCH transmission occasion collides with the TRS, the PDCCH MO or SS, or the SSB.

21. The method of claim 19, wherein selectively transmitting the PUSCH communication or the PUCCH communication includes selectively transmitting the PUSCH communication or the PUCCH communication based at least in part on whether the PUSCH communication or the PUCCH communication is dropped due to a collision between:
the PUSCH transmission occasion or the PUCCH transmission occasion, and the TRS, the PDCCH MO or SS, or the SSB.

22. The method of claim 19, wherein the PUSCH communication is transmitted in the PUSCH transmission occasion when the PUSCH transmission occasion is available.

23. The method of claim 22, wherein the PUSCH communication is a configured grant (CG) PUSCH communication associated with transport block (TB) processing over multiple slots (TBoMS).

24. The method of claim 19, wherein the PUCCH communication is transmitted in the PUCCH transmission occasion when the PUCCH transmission occasion is available.

25. A method of wireless communication performed by a network node, comprising:
transmitting a semi-static physical uplink shared channel (PUSCH) or physical uplink control channel (PUCCH) configuration; and
selectively receiving, in accordance with the semi-static PUSCH or PUCCH configuration, a PUSCH communication or a PUCCH communication in a PUSCH transmission occasion or a PUCCH transmission occasion of a sub-band full duplex (SBFD) slot based at least in part on an availability of the PUSCH transmission occasion or the PUCCH transmission occasion, wherein the PUSCH transmission occasion or the PUCCH transmission occasion is unavailable when the PUSCH transmission occasion or the PUCCH transmission occasion at least partially collides with a tracking reference signal (TRS), a physical downlink control channel (PDCCH) monitoring occasion (MO) or search space (SS), or a synchronization signal block (SSB).

26. The method of claim 25, wherein the PUSCH transmission occasion or the PUCCH transmission occasion at least partially collides with the TRS, the PDCCH MO or SS, or the SSB when at least one symbol of a time domain resource allocation (TDRA) associated with the PUSCH transmission occasion or the PUCCH transmission occasion collides with the TRS, the PDCCH MO or SS, or the SSB.

27. The method of claim 25, wherein selectively receiving the PUSCH communication or the PUCCH communication includes selectively receiving the PUSCH communication or the PUCCH communication based at least in part on whether the PUSCH communication or the PUCCH communication is dropped due to a collision between:
the PUSCH transmission occasion or the PUCCH transmission occasion, and
the TRS, the PDCCH MO or SS, or the SSB.

28. The method of claim 25, wherein the PUSCH communication is transmitted in the PUSCH transmission occasion when the PUSCH transmission occasion is available.

29. The method of claim 28, wherein the PUSCH communication is a configured grant (CG) PUSCH communication associated with transport block (TB) processing over multiple slots (TBoMS).

30. The method of claim 25, wherein the PUCCH communication is transmitted in the PUCCH transmission occasion when the PUCCH transmission occasion is available.
